(19) United States
(12) Patent Application Publication
(10) Pub. No.: US 2001/0033131 A1
(43) Pub. Date: Oct. 25, 2001

(54) Color display tube

(76) Inventors: Jacobus Hubertus Theodoor Jamar, Eindhoven (NL); Albertus Aemilius Seyno Sluyterman, Eindhoven (NL)

Correspondence Address: Corporate Patent Counsel, U.S. Philips Corporation, 580 White Plains Road, Tarrytown, NY, 10591, US

(21) Appl. No.: 09/811,639

(22) Filed: Mar. 19, 2001

(30) Foreign Application Priority Data
Mar. 20, 2000 (EP) 00201005.6

(51) Int. Cl. H01J 29/50; H01J 29/80

(52) U.S. Cl. 313/414; 313/402; 313/421

(57) ABSTRACT

The color display tube (1) has a display window (3) and a curved shadow mask (13). The inner surface (15) of the display window (3) may be substantially flat or it may be curved with a curvature smaller than the curvature of the shadow mask (13). The distance Qₚ from the shadow mask (13) to the screen (6) at the inner surface (15) of the display window (3) of the color display tube (1) according to the invention is larger by a positive integer, not being a multiple of three, for all positions p on the screen (6) than this distance Q⁰ₚ in prior art tubes.

As a result, the mask has a stronger curvature than for prior art tubes. This has for its effect an increased stability of the shape of the shadow mask (13), thereby avoiding the deterioration of the performance of the color display tube (1) compared to important parameters such as color purity—due to doming—and microphony.

The invention relates to a color display tube comprising a display window having an inner side which is provided with a screen, a curved shadow mask with a pattern of apertures and positioned at a distance from the screen, and an electron gun generating, in operation, three electron beams in a plane, which are deflected by a deflection device having a deflection plane to scan all positions on the screen.

A color display tube as described in the opening paragraph is known from European Patent Application EP-A-0968514. In this document a color display tube is described that has a curved shadow mask and a substantially flat outer surface of the display window. The color display tube is provided with two quadrupoles which modulate the trajectories of the electron beams necessitating a shadow mask that is more curved, compared to color display tubes without the additional quadrupoles. This additional curvature is preferably present in a direction perpendicular to the plane in which the electron beams are generated.

In present-day designs of color display tubes, there is a tendency to flatter and even completely flat display windows. Preferably, a flat outer surface of the display window is accompanied with a flat inner surface. In principle, this would require a flat or almost flat shadow mask. Such a shadow mask has the disadvantage that it goes at the expense of the performance of the color display tube; important parameters such as, for instance, color purity—due to doming—and microphony show a declining performance, because the stability of the shadow mask decreases when it becomes flatter. For color display tubes with a flat inner surface the stability of the shadow mask according to EP-A-0968514 is too critical, resulting in a color display tube with an insufficient performance with respect to color purity and microphony. The color display tube known from EP-A-0968514 further shows the disadvantage that when a shadow mask is present which has its additional curvature in a direction parallel to the plane in which the electron beams are generated, the spot performance—also referred to as resolution—of the color display tube may be influenced in a negative way.

Another disadvantage of the color display tube disclosed in EP-A-0968514 is the fact that it is rather complicated. It requires additional coils—the quadrupoles—and power supplies for these coils, which increase the power consumption of the color display tube in use.

It is an object of the invention to provide a color display tube of the kind mentioned in the opening paragraph, in which the performance with respect to color purity and microphony is significantly improved and the spot performance is maintained, even if the color display tube has a display window with a substantially flat inner surface.

It is another object of the invention to provide a color display tube of the said kind, which is simple in construction, cheaper, and uses less energy than the color display tubes known from the prior art.

These objects are realized with a color display tube according to the invention, which is characterized in that the distance between the shadow mask and the screen for each position p on the screen, denoted by Qₚ, is given to be approximately

$${Q}_{p} = ( 3 n \pm 1 ) \cdot \frac{{a}_{m} \cdot {L}_{p}}{3 \cdot s}$$

in which,

aₘ is the distance between two adjacent apertures in the color selection electrode in a direction parallel to the plane in which the electron beams are generated,

Lₚ is the distance between the position of the electron beam in the deflection plane and the position p on the screen,

s is the mutual distance between the electron beams at the position of the deflection plane,

and n is a positive integer.

The invention is based on the recognition that a very efficient way of increasing the stability of the shadow mask is by increasing its curvature. Current color display tubes are provided with a mask that is stronger curved than the screen on the inside of the display window, the distance between the mask and screen increases from the center to the edges of the display window. This situation is accomplished in most cases by increasing the phosphor pitch—that is the distance between two adjacent triplets on the screen—from the center to the edges.

For current color display tubes, the mask-to-screen distance, denoted by Q⁰ₚ is approximately given by:

$${Q}_{p}^{0} = \frac{{a}_{m} \cdot {L}_{p}}{3 \cdot s}$$

According to the present invention, the mask curvature has been increased by multiplying the mask-to-screen distance by a fixed number for all positions of the screen. In order to make sure that the electron beams hit the screen at locations where phosphors of the appropriate colors are deposited, this number must be a positive integer. From these positive integers, the multiples of three must be excluded, because such a choice leads to the situation that all the electrons hit the center phosphor of a triplet. In case the number is 3n±1, all three colors of phosphors are excited, but a triplet is no longer the collection of three adjacent phosphors of different colors, but they are overlapping with neighboring triplets. A triplet is defined as the combination of a red, a green and a blue phosphor element, excited by electrons which originate from the same aperture in the shadow mask.

In a preferred embodiment the distance between the shadow mask and the screen is

$${Q}_{p} = 2 \cdot \frac{{a}_{m} \cdot {L}_{p}}{3 \cdot s}$$

In this situation, the mask-to-screen distance has been doubled in comparison with the current color display tubes, leading to an increased curvature of the mask. Such a color display tube gives the best compromise between doming and microphony performance on one hand and other tube parameters such as magnetic shielding performance and the ability to be manufactured on the other. In current color display tubes, the electrons are shielded from the influence of external magnetic fields, such as the earth magnetic field, by the inner magnetic shield and by the shadow mask. The space between the shadow mask and the screen is not shielded, which makes that the electron beams are susceptible to external magnetic fields in this space. This may lead to a lower color purity performance. A larger mask-to-screen distance will enhance this effect. It is more difficult to design a color display tube in which the mask-to-screen distance is multiplied by an integer larger than two, because this may cause problems in suspending the color selection electrode, which includes the shadow mask, in an upright edge of the display window. Also the large mask-to-screen distance leads to a poorer performance with respect to the magnetic shielding, because the electrons travel over a larger distance in a space that is not shielded, leading to a color picture tube with worse color purity.

It should be mentioned that in KR-9405493 a color display tube is disclosed with a doubled mask-to-screen distance. However, in this document this measure is taken for improving the moiré performance of the tube. It does not solve the problem for which the present invention gives a solution. In KR-9405493, it is said that: ‘the gap between the shadow mask and the face panel is made a constant value’. Therefore, the shadow mask and the face panel—also referred to as display window—are parallel. This directly implies that by multiplying this constant value with a certain integer, it remains a constant value, and so, the mask and the face panel remain parallel, excluding the possibility of having a more curved mask. In this way, it is not possible to solve the problem for which the present invention gives a solution.

A further embodiment is characterized in that the inner side of the display window is substantially flat. In a color display tube with a flat inner side of the display window and a certain amount of pitch grading, the shadow mask is only slightly curved. This makes the mask stability much more critical and the color purity and microphony performance deteriorate. This kind of color display tube benefits most from the invention.

A still further embodiment is characterized in that the display window comprises a circumferential upright edge with corner areas to which supporting elements are secured and the color selection electrode has a frame comprising corner sections to which suspension means are coupled, which color selection electrode is suspended from the supporting elements. This embodiment is a color display tube in which the color selection electrode is suspended in the corners of the upright edge of the display window. This type of suspension is commonly used in TV tubes of which new designs tend to become increasingly flat. Therefore, the color purity and microphony performance of this kind of tubes strongly benefit from the present invention.

A still further embodiment is characterized in that the color display tube has a display window with an aspect ratio of 16:9. The use of these color display tubes, referred to as wide-screen tubes, will strongly increase in the near future, especially in combination with a flat display window.

These and other aspects of the invention are apparent from and will be elucidated by way of non-limitative examples with reference to the drawings and the embodiments described hereinafter.

In the drawings:

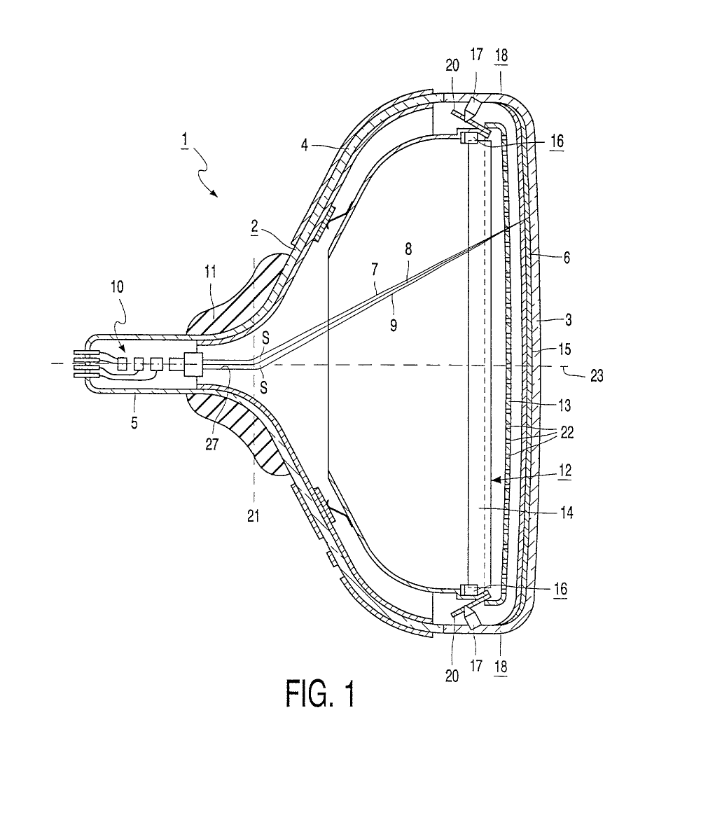

FIG. 1 is a schematically sectional view of a color display tube according to the invention;

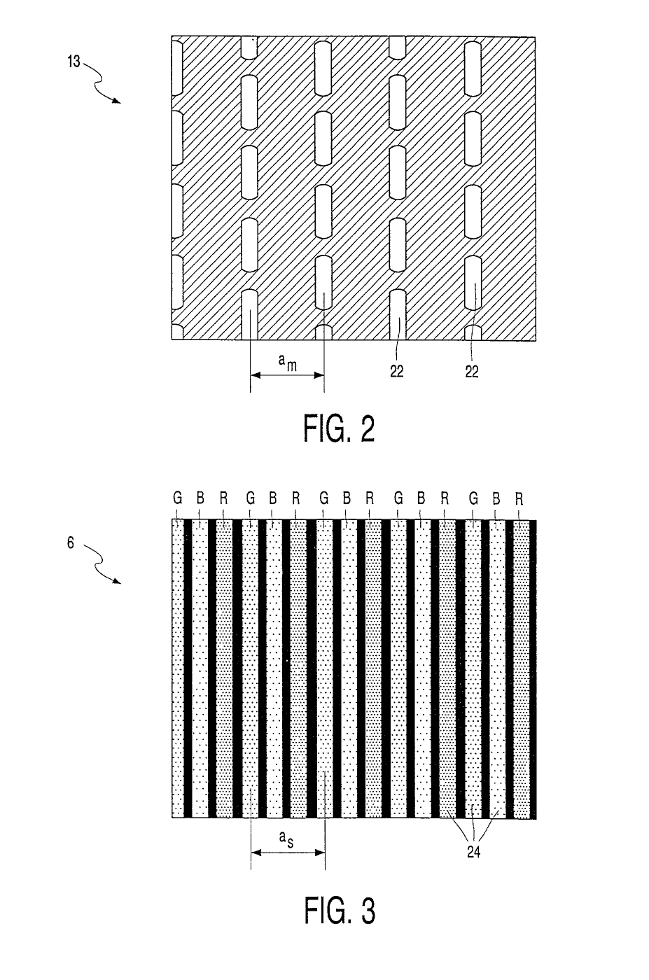

FIG. 2 is a part of a shadow mask with a pattern of slotted apertures;

FIG. 3 is a part of a screen of a color display tube provided with a shadow mask with a pattern of slotted apertures;

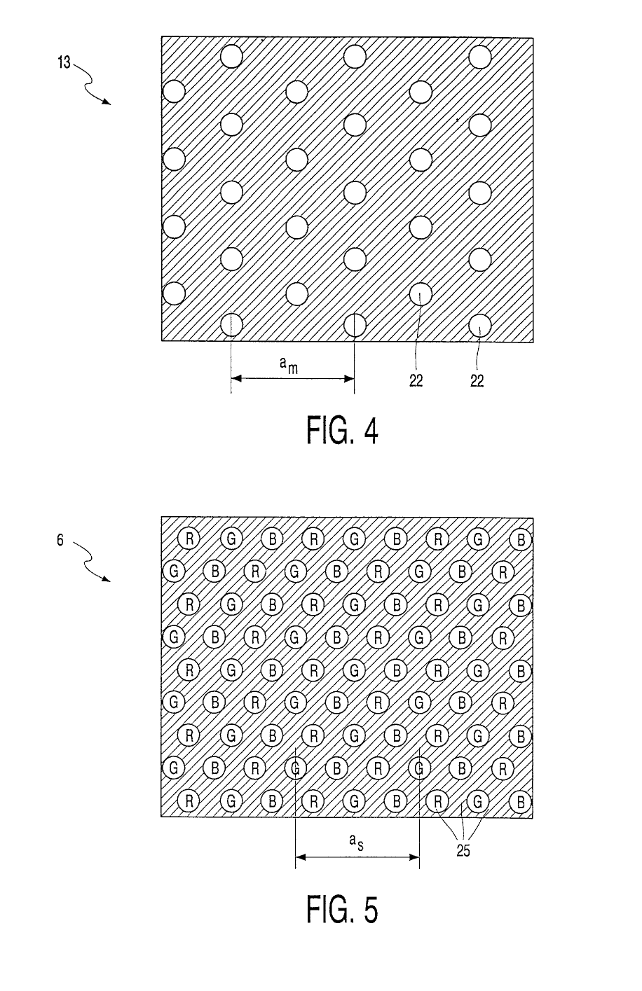

FIG. 4 is a part of a shadow mask with a pattern of dotted apertures;

FIG. 5 is a part of a screen of a color display tube provided with a shadow mask with a pattern of dotted apertures;

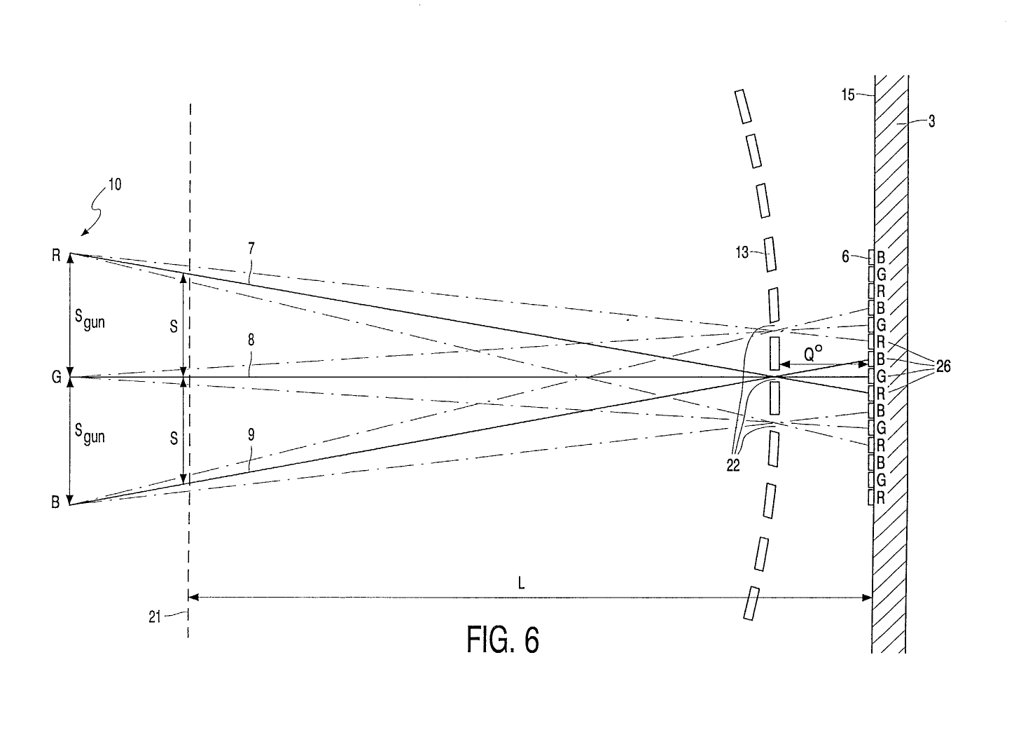

FIG. 6 gives the trajectories of the electron beams from the electron gun to the screen of a small part of the screen of a color display tube of the prior art;

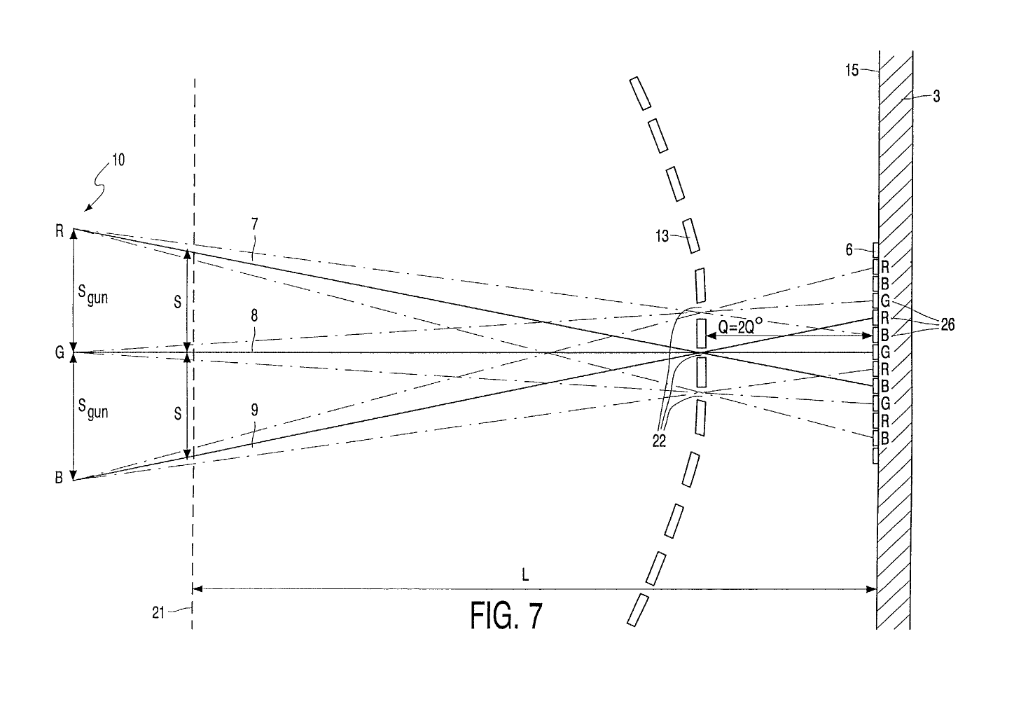

FIG. 7 gives the trajectories of the electron beams from the electron gun to the screen of a small part of the screen of the color display tube according to the invention;

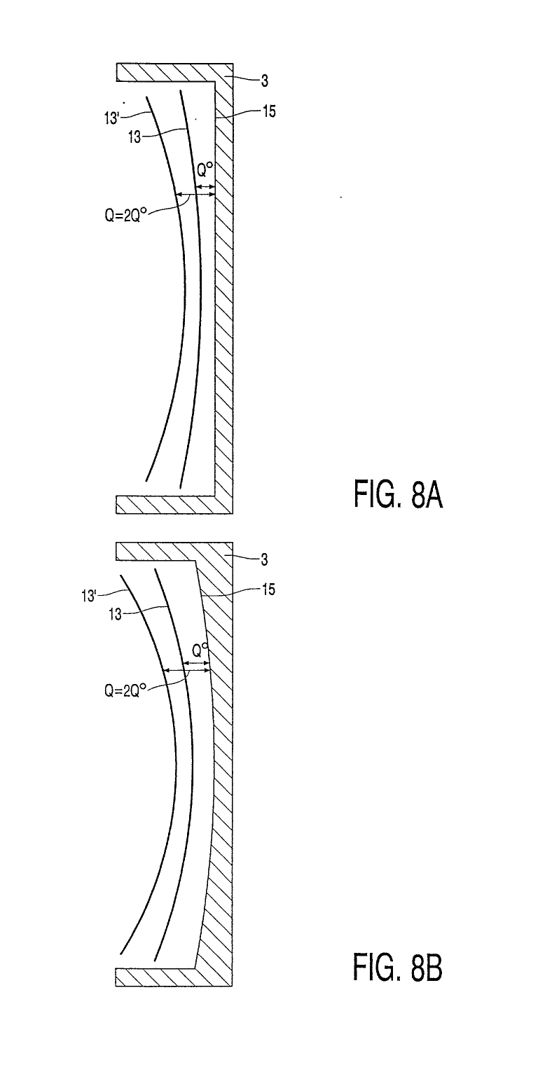

FIGS. 8A and 8B schematically give the shape of the shadow mask for a single and double mask-to-screen distance for a color display tube with a flat and with a curved inner surface of the display window respectively.

The color display tube 1 shown in FIG. 1 comprises an evacuated glass envelope 2 with a display window 3, a funnel shaped part 4 and a neck 5. On the inner side 15 of the display window 3 is arranged, a screen 6 having a pattern of for example lines (see FIG. 3) or dots (see FIG. 5) of phosphors luminescing in different colors (e.g. red, green and blue). The phosphor pattern is excited by the three electron beams 7, 8 and 9 which are generated—in a plane 27 coinciding with the sheet of the Figure—by the electron gun 10. On their way to the screen 6 the electron beams 7, 8 and 9 are deflected by the deflection unit 11 ensuring that the electron beams 7, 8 and 9 systematically scan the screen 6. A plane, which is referred to as the deflection plane 21, can be calculated which coincides with the virtual points at which the deflected electron beams 7, 8 and 9 seem to be deflected. The distance between the central electron beam 8 and the side beams 7 and 9 at the deflection plane 21 is called s.

Before the electron beams 7, 8, 9 hit the screen 6, they pass through a color selection electrode 12. This color selection electrode 12 comprises a shadow mask 13, which is the real color-selective part: it intercepts the electron beams 7, 8, 9 so that they only hit the phosphor of the appropriate color. The mask 13 has a pattern of apertures 22 which may be, for example, of the slotted or dotted type. Furthermore, the color selection electrode 12 comprises the frame 14 for supporting the shadow mask 13.

The color selection electrode 12, which is given as an example in FIG. 1, is suspended from the display window 3 by using supporting elements 17, which are secured in the corner areas of the upright edge 18 of the display window 3. For suspending the color selection electrode 12, the frame 14 is having, amongst others, corner sections 16 to which the suspension means 20 are coupled.

FIG. 2 shows part of the shadow mask 13, which is of the slotted type. Masks of this type are commonly used in color display tubes 1 for TV applications. The apertures 22 in this type of shadow mask are strongly elongated. The distance between two columns of elongated apertures 22 is the mask pitch aₘ. In most applications this mask pitch is in the horizontal direction, that is, in a direction parallel to the plane 27 in which the three electron beams 7, 8 and 9 are generated. The columns with elongated apertures 22 are in the vertical direction. The corresponding phosphor structure of the screen 6 is given in FIG. 3. The manufacturing process makes that the elongated apertures in the mask are transformed in a pattern 24 of phosphor stripes on the screen 6. The screen pitch a_{s,} being the distance between two consecutive phosphor lines of the same color, is indicated in FIG. 3. It is noticed that the screen pitch aₛ is slightly larger than the mask pitch a_{m,} due to the magnification of shadow mask 13 when it is imaged on the screen 6.

FIG. 4 shows part of an alternative shadow mask 13 of the dotted type, as is commonly used in color display tubes for computer monitors. The apertures 22 in this type of shadow mask are nearly round or are slightly elongated. The distance between two adjacent apertures of the shadow mask 13 in a direction parallel to the plane 27 in which the electron beams 7, 8, 9 are generated is called the mask pitch a_{m;} mostly this is the horizontal mask pitch. The phosphor structure of the screen 6 belonging to this type of shadow mask 13 is given in FIG. 5. Here, one aperture 22 in the shadow mask 13 corresponds to a triplet of apertures 25 on the screen 6, having a screen pitch a_{s,} which for this type of shadow mask 13 is also slightly larger than the mask pitch aₘ.

FIG. 6 gives the trajectories of the electron beams 7, 8, 9 from the electron gun 10 to the screen 6 of a prior art color display tube 1. At the position of the electron gun 10, the mutual distance of the electron beams 7, 8, 9 is given by s_{gun,} which distance is slightly larger than their distance s at the location of the deflection plane 21. This Figure shows that electrons of the three electron beams 7, 8 and 9 passing through the same aperture 22 in the shadow mask 13 reach the screen 6 at adjacent phosphor elements 26 corresponding to the three colors such as, for instance, red, green and blue. So, a triplet—that is the three phosphor elements 26 excited through one aperture 22 of the shadow mask 13—is formed by three adjacent phosphor elements 26 of the three colors. The mask-to-screen distance for the prior art tube is called Q^{0.}

FIG. 7 gives an illustration of a part of the color display tube 1 according to the present invention for which the mask-to-screen distance has been doubled compared to the prior art color display tube 1 from FIG. 6, so Q=2.Q⁰. It is seen that electrons from the three electron beams 7, 8 and 9 passing through the same aperture 22 in the shadow mask 13 do not reach the screen 6 at adjacent phosphor elements 26. The intermediate phosphor elements 26 are excited by electrons passing through neighboring apertures 22 in the shadow mask 13.

In fact, by doubling the mask-to-screen distance Q compared to the prior art, the phosphor elements 26 excited by the outer electron beams 7 and 9 are shifted one phosphor element away from the central phosphor element excited by the central electron beam 8. Furthermore, it is seen that the colors of the phosphor excited by the two outer electron beams have interchanged.

By multiplying the mask-to-screen distance by three, so Q=3.Q⁰, the phosphor elements 26 excited by the outer electron beams 7 and 9 are shifted two phosphor elements away from the central phosphor element excited by the central electron beam 8, resulting in that all electrons will hit the phosphor originally corresponding to the central beam 8. This makes it impossible to display a color picture in case the mask-to-screen distance is tripled, so multiples of three are excluded.

In general, when Q=(3n−1).Q⁰, the outer electron beams 7 and 9 passing through the same aperture 22 are shifted 3n−2 phosphor elements 26 away from the central element and the color of the phosphor excited by of the outer electron beams 7 and 9 interchange. For Q=(3n+1).Q⁰, the outer electron beams 7 and 9 passing through the same aperture 22 are shifted 3n phosphor elements 26 away from the central element and the color of the phosphor excited by of the outer electron beams 7 and 9 is not changed.

By example, FIGS. 8A and 8B give, schematically, a display window 3 and a shadow mask 13 of a color display tube 1 in which the invention is applied. FIG. 8A shows a display window 3 with a flat inner surface 15; in FIG. 8B the inner surface 15 is curved. In these Figures, the shadow mask is indicated by 13 for the prior art situation having a mask-to-screen distance Q⁰ and by 13′ for the situation according to the present invention where the mask-to-screen distance has been doubled. It is clear that, by doubling the mask-to-screen distance, the curvature of the shadow mask 13′ has increased compared to the curvature of shadow mask 13. Evidently, this situation only occurs when in the prior art situation the mask-to-screen distance increases at deflection, at either horizontal and/or vertical direction. This increase of mask-to-screen distance can, for instance, be obtained by designing a color display tube 1 with pitch grading. This means that the pitch on the screen, and also on the mask, increases on deflection. From the defining formula for Q⁰ it is obvious that this implies an increase of the mask-to-screen distance.

Application of the invention is not limited to the examples as described. It is also applicable to color display tubes 1 with a curved outer surface, and thus also a curved inner surface, of the display window 3. Furthermore it can be used in color display tubes 1 with another type of electron gun 10, for instance, an electron gun in which the three beams 7, 8, 9 are generated on the vertices of a triangle, referred to as delta-gun.

Another advantage of this invention may be found in the substitution of the expensive invar shadow mask by the much cheaper akoca (iron) shadow mask. The additional curvature of the shadow mask 13 improves the performance to such a degree that it enables the use of an akoca mask and still maintains the required performance in doming and microphony.

Further, the invention can be combined with the features disclosed in EP-A-0968514. A very robust design with respect to the positional stability of the shadow mask 13 is obtained by increasing the mask curvature by using the double quadrupole system—which decreases the pitch s of the electron beams at the location of the deflection plane 21—and additionally doubling of the mask-to-screen distance.

In summary, the color display tube 1 has a display window 3 and a curved shadow mask 13. The inner surface 15 of the display window 3 may be substantially flat or it may be curved with a curvature smaller than the curvature of the shadow mask 13.

The distance Qₚ from the shadow mask 13 to the screen 6 at the inner surface 15 of the display window 3 of the color display tube 1 according to the invention is larger by a positive integer, not being a multiple of three, for all positions p on the screen 6 than this distance Q⁰ₚ in prior art tubes.

As a result, the mask has a stronger curvature than for prior art tubes. This has for its effect an increased stability of the shape of the shadow mask 13, thereby avoiding the deterioration of the performance of the color display tube 1 compared to important parameters such as color purity—due to doming—and microphony.

What is claimed is:

1. A color display tube (1) comprising a display window (3) having an inner side (15) which is provided with a screen (6), a curved shadow mask (13) with a pattern of apertures (22) and positioned at a distance from the screen (6), and an electron gun (10) generating, in operation, three electron beams (7, 8, 9) in a plane (27), which are deflected by a deflection device (11) having a deflection plane (21) to scan all positions on the screen (6), characterized in that the distance between the shadow mask (13) and the screen (6) for each position p on the screen (6), denoted by Qₚ, is given to be approximately
$${Q}_{p} = ( 3 n \pm 1 ) \cdot \frac{{a}_{m} \cdot {L}_{p}}{3 \cdot s}$$
in which,
aₘ is the distance between two adjacent apertures (22) in the color selection electrode (12) in a direction parallel to the plane (27) in which the electron beams (7, 8, 9) are generated,
Lₚ is the distance between the position of the electron beam (7, 8, 9) in the deflection plane (21) and the position p on the screen (6),
s is the mutual distance between the electron beams (7, 8, 9) at the position of the deflection plane (21),
and n is a positive integer.

2. A color display tube (1) as claimed in claim 1, characterized in that
$${Q}_{p} = 2 \cdot \frac{{a}_{m} \cdot {L}_{p}}{3 \cdot s}$$

3. A color display tube (1) as claimed in claim 1 or 2, characterized in that the inner side of the display window (3) is substantially flat.

4. A color display tube (1) as claimed in claim 1, 2 or 3, characterized in that the display window (3) comprises a circumferential upright edge (18) with corner areas to which supporting elements (17) are secured and a color selection electrode (12), comprising the shadow mask (13), has a frame (14) comprising corner sections (16) to which suspension means (20) are coupled, which color selection electrode (12) is suspended from the supporting elements (17).

5. A color display tube (1) as claimed in claim 1, 2, 3 or 4 characterized in that the color display tube (1) has a display window (3) with an aspect ratio of 16:9.
